(19) United States
(12) Patent Application Publication
(10) Pub. No.: US 2007/0018515 A1
(43) Pub. Date: Jan. 25, 2007

(54) Air driven power generating device

(75) Inventors: Jyh-Chun Chang, Tucheng City (TW); Chu-Shu Tsai, Taipei City (TW); Hsiang-Chi Liu, Fengshan City (TW); Fuh-Yu Chang, Zhubei City (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 11/184,985

(22) Filed: Jul. 20, 2005

(51) Int. Cl. H02K 7/18; H02K 7/14; H02K 21/12

(52) U.S. Cl. 310/50; 290/1 R; 310/156.32; 310/207

(57) ABSTRACT

An air-driven power generating device, comprising: an air-driven portion; a planar magnet, disposed on the air-driven portion and having a plurality of magnetic poles for generating an alternate magnetic field, the planar magnet being driven by the air-driven portion so as to change the alternate magnetic field; a planar coil, disposed apart from the planar magnet for a distance, the planar coil having a plurality of induced regions so as to induce the alternate magnetic field to generate an induced electromotive force (EMF); and a control circuit, electrically connected to the planar coil.

### BACKGROUND OF THE INVENTION

1. Field of the Invention

The present invention generally relates to a power generating device and, more particularly, to an air-driven power generating device using air to drive a planar magnet to rotate such that a planar coil cuts through a magnetic field generated by the planar magnet so as to generate an induced electromotive force (EMF).

2. Description of the Prior Art

With the high development in nano-engineering and micro electro-mechanical systems (MEMS) technologies, industries in many fields such as mechanics, opto-electronics, micro-electronics, materials and bio-engineering have made a breakthrough in product precision, performance and cost.

Even though the new technology makes it possible to design precise devices, the devices are still powered up by external driving devices or power modules that are large in size and hinder the technology from moving towards precision and downsizing.

Energy resources have now become a major issue because of environmental concerns. Therefore, research topics on substitutes such as solar cells, fuel cells and on power generators have attracted a great amount of attention.

For example, U.S. Pat. No. 4,777,394 and U.S. Pat. No. 5,982,059 disclose generators using a cup-shaped supporting shell for fixing a yoke assembly so as to generate an induced electromotive force; however, these patents have disadvantages in that the power generators are large in size. Moreover, U.S. Pat. No. 5,525,842 discloses a power generating device, installed in an air-driven tool, capable of driving a magnet to rotate and thus generate an induced electromotive force using a solenoid; however, this patent is disadvantageous in that the structure is complicated, costly and low efficiency in power generating.

Therefore, there is need in providing an air-driven power generating device to overcome the problems that appear in the prior art.

### SUMMARY OF THE INVENTION

It is a primary object of the present invention to provide an air-driven power generating device using air to drive a planar magnet to rotate such that a planar coil cuts through a magnetic field generated by the planar magnet so as to generate an induced electromotive force (EMF).

In order to achieve the foregoing object, the present invention provides an air-driven power generating device, comprising: an air-driven portion; a planar magnet, disposed on the air-driven portion and having a plurality of magnetic poles for generating an alternate magnetic field, the planar magnet being driven by the air-driven portion so as to change the alternate magnetic field; a planar coil, disposed apart from the planar magnet for a distance, the planar coil having a plurality of induced regions so as to induce the alternate magnetic field to generate an induced electromotive force (EMF); and a control circuit, electrically connected to the planar coil so as to provide rectification, power storage, and power transmission.

The power generating device of the present invention is applicable to a variety of air-driven tools so that the air-driven tools generate power for illumination for the tool, torque detection, display, digitalization, and so on.

It is preferable that the air-driven portion performs a rotating motion so as to drive the planar magnet to rotate.

It is preferable that the air-driven portion communicates with a pipe with a high-pressure gas flow, thereby driving the air-driven portion to rotate.

It is preferable that the planar magnet is a multi-polar magnet.

It is preferable that the planar coil comprises a plurality patterned coils.

It is preferable that the plurality patterned coils are electrically connected in series or in parallel.

### BRIEF DESCRIPTION OF THE DRAWINGS

The objects, spirits and advantages of the preferred embodiment of the present invention will be readily understood by the accompanying drawings and detailed descriptions, wherein:

FIG. 1 is a 3-D exploding view showing an air-driven power generating device in accordance with one embodiment of the present invention;

FIGS. 2A and 2B are schematic diagrams showing a planar magnet and a planar coil with corresponding magnetic poles of the present invention;

FIG. 3A is a schematic diagram showing the pattern of a planar coil of the present invention;

FIG. 3B is a schematic diagram showing a planar coil comprising a plurality of patterned coils that are electrically connected in parallel of the present invention;

FIG. 3C is a schematic diagram showing a planar coil comprising a plurality of patterned coils that are electrically connected in series of the present invention;

FIG. 4 is a cross-sectional view showing an air-driven lighting device using an air-driven of the present invention;

FIG. 5A is a 3-D exploding view showing an air-driven hand tool using an air-driven of the present invention; and

FIG. 5B is a 3-D view of the air-driven hand tool of FIG. 5A.

### DETAILED DESCRIPTION OF THE PREFERRED EMBODIMENT

The present invention providing air-driven power generating device can be exemplified by the preferred embodiment as described hereinafter.

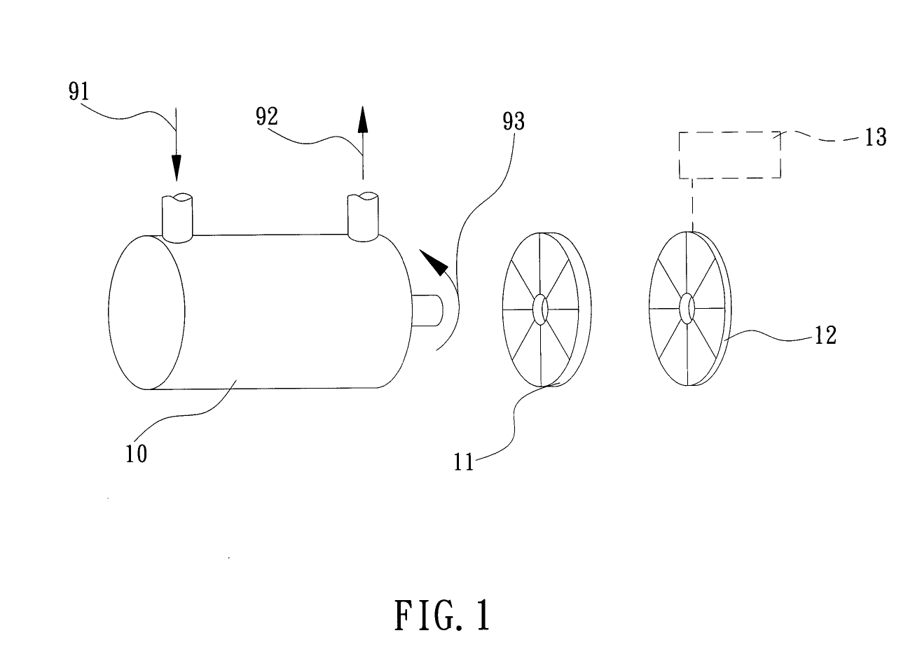

Please refer to FIG. 1, which is a 3-D exploding view showing an air-driven power generating device in accordance with one embodiment of the present invention. The air-driven power generating device 1 comprises: an air-driven portion 10; a planar magnet 11, a planar coil 12, and a control circuit 13. The air-driven portion 10 rotates as indicated by an arrow 93 due to air circulation caused by input air 91 and output air 92. The planar magnet 11 is disposed on the air-driven portion 10 and rotates with the air-driven portion 10. The planar magnet 11 has a plurality of magnetic poles for generating an alternate magnetic field. In the present embodiment, the planar magnet 11 is a multi-polar magnet. The planar coil 12 is disposed apart from the planar magnet 11 for a distance and has a plurality of induced regions so as to induce the alternate magnetic field to generate an induced electromotive force (EMF). In the present embodiment, the planar coil 12 is made of a conductive metal wire. The control circuit 13 is electrically connected to the planar coil 12. The control circuit 13 provides rectification, electricity storage and power transmission.

Moreover, the planar magnet 11 rotates with the air-driven portion 10. According to Lenz's Law, the alternate magnetic field generated by the planar magnet 11 changes when the planar magnet 11 rotates. Therefore, the planar coil 12 generates an induced electromotive force (EMF) due to resistance to the change of the alternate magnetic field, leading to an induced current in the closed loop.

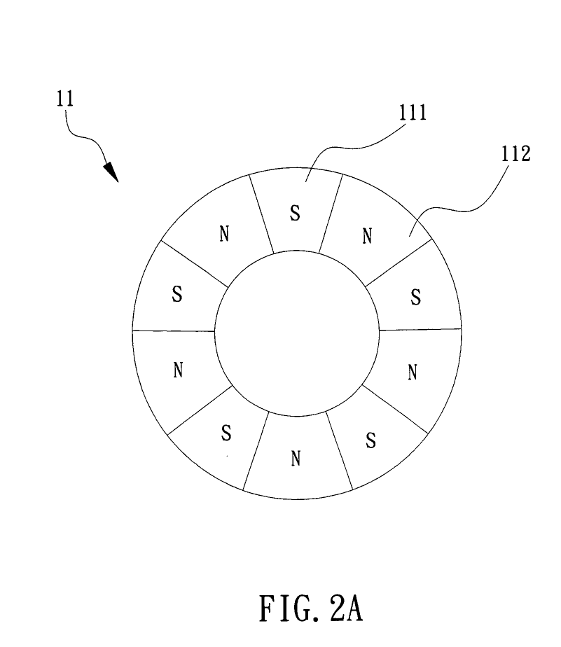

Please further refer to FIGS. 2A and 2B, which are schematic diagrams showing a planar magnet and a planar coil with corresponding magnetic poles of the present invention. As shown in the drawings, magnetic poles 111 and 112 of the planar magnet 11 correspond to induced regions 121 and 122. The induced electromotive force (EMF) increases with the number of the magnetic poles and the windings of the planar coil.

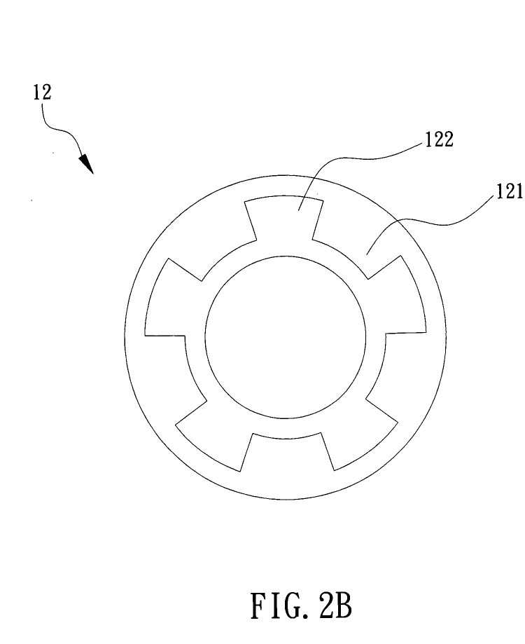

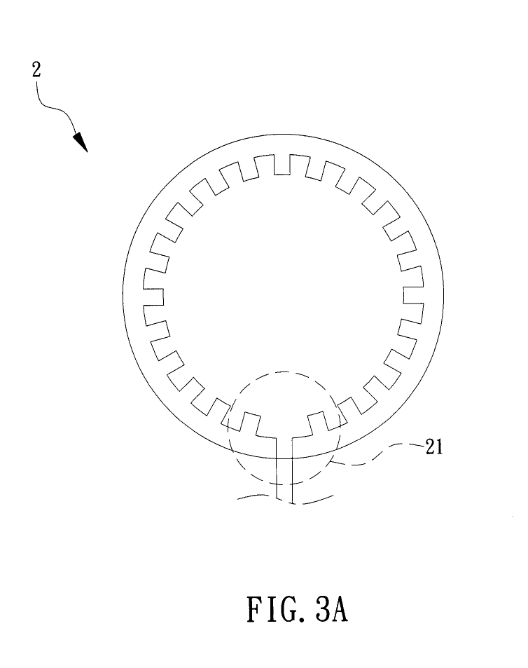

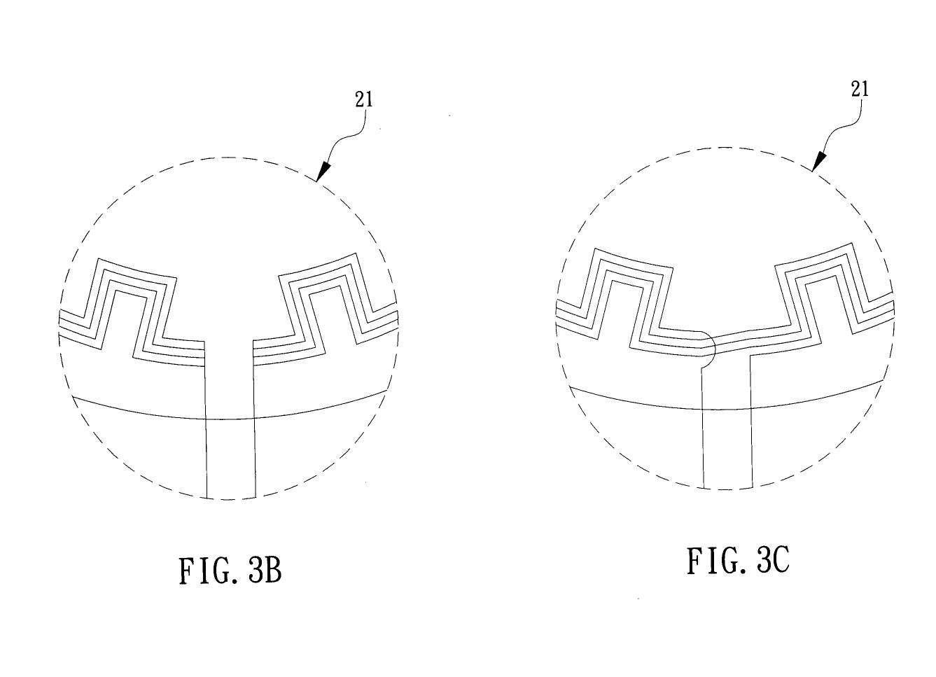

Please also refer to FIG. 3A, which is a schematic diagram showing the pattern of a planar coil of the present invention. In FIG. 3A, the planar coil comprises a plurality patterned coils. FIGS. 3B and 3C are schematic diagram showing how the plurality of patterned coils are connected. More particularly, the plurality of patterned coils 21 are electrically connected in series as shown in FIG. 3B and the plurality of patterned coils 21 are electrically connected in series as shown in FIG. 3C.

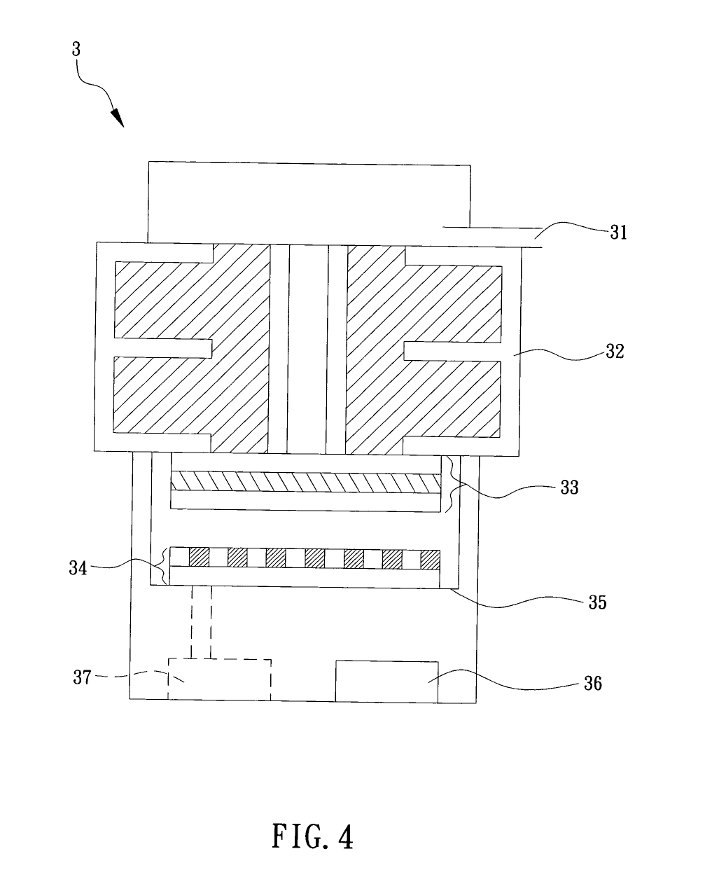

Please refer to FIG. 4, which is a cross-sectional view showing an air-driven lighting device using an air-driven of the present invention. The air-driven lighting device 3 comprises an air-driven rotating means 32, a planar magnet 33 connected to the air-driven rotating means 32, a planar coil 34 disposed on a substrate 35 and being apart from the planar magnet 33 for a distance, and a lighting element 36. In the present embodiment, the air-driven rotating means 32 communicates with a pipe 31 with a high-pressure gas flow. The air-driven rotating means 32 is driven to rotate by the high-pressure gas flow, thereby driving the planar magnet 33 to rotate so as to induce the alternate magnetic field to generate an induced electromotive force (EMF). Then, a current is generated in the loop and drives the lighting element 36. The air-driven lighting device 3 further comprises a control circuit 37 so as to provide rectification, electricity storage and power transmission.

In the present embodiment, the distance between the planar magnet 33 and the planar coil 34 is only exemplary and can be modified by those with ordinary skill in the art. Moreover, modifications on the air-driven rotating means 32 for driving the planar magnet 33 are within the scope of the present invention.

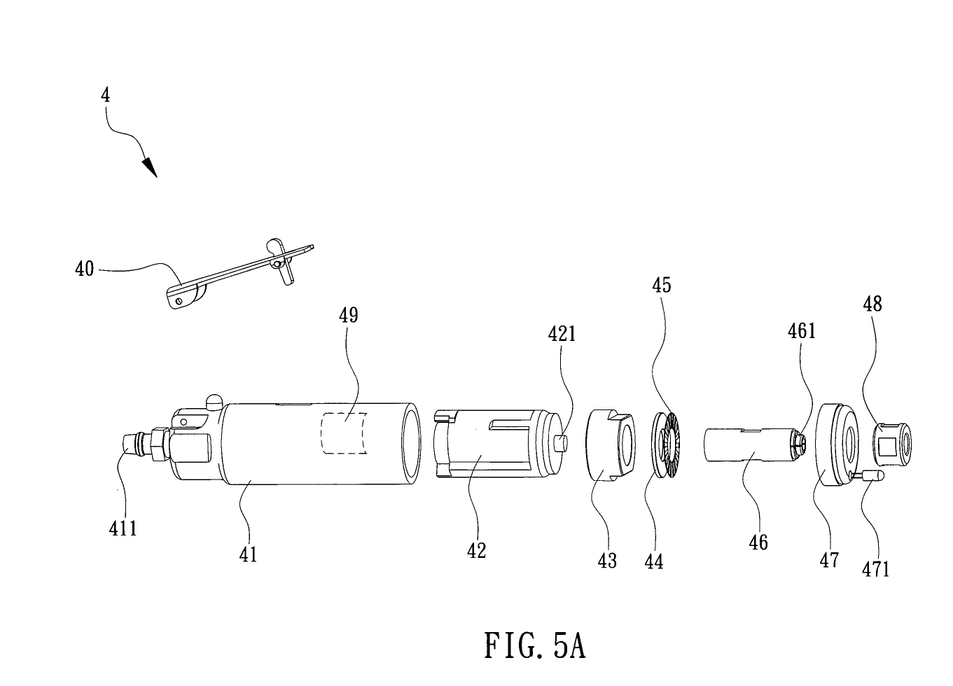

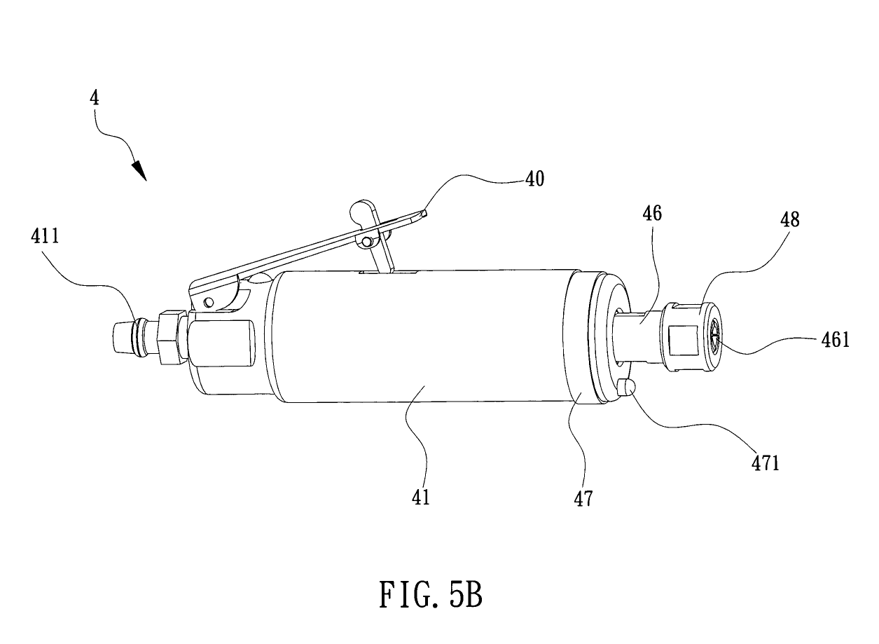

Please refer to FIG. 5A, which is a 3-D exploding view showing an air-driven hand tool using an air-driven of the present invention. The air-driven hand tool 4 comprises an air-driven rotating means 42 installed in a housing 41. The housing 41 has an inlet 411 for receiving air so as to drive the air-driven rotating means 42. A control switch 40 is disposed on the housing 41 so as to control the air-driven rotating means 42. The air-driven hand tool 4 is connected to one side of the housing 41 via a first cap 43 so as to enclose the air-driven rotating means 42 inside the housing 41. A shaft 421 on the front of the air-driven rotating means 42 is connected to a rotating clutch 46 such that the air-driven rotating means 42 rotates as the shaft 421.

Moreover, a planar magnet 44 (as a rotator) is fixedly disposed on the rotating clutch 46. A planar coil 45 (as a stator) is fixedly disposed in a second cap 47, which is connected to the first cap 43, so that the planar magnet 44 is apart from the planar coil 45 for a distance and both the planar magnet 44 and the planar coil 45 are installed in a compartment formed by the first cap 43 and the second cap 47. A lighting element 471 is disposed on the front of the second cap 47. Moreover, the size of a clip 461 on the front of the rotating clutch 46 is controlled by a cover 48 so as to tightly hold a tool. The air-driven hand tool 4 further comprises a control circuit 49 that provides rectification, electricity storage and power transmission. As shown in FIG. 5B, which is a 3-D view of the air-driven hand tool of FIG. 5A, the air-driven rotating means 42 is driven by air flowing into the inlet 411 so as drive the rotating clutch 46 to rotate. The planar magnet 44 is therefore driven to rotate so as to enable the planar coil 45 to induce the alternate magnetic field to generate an induced electromotive force (EMF) for the lighting element 471.

According to the above discussion, it is apparent that the present invention discloses an air-driven power generating device using air to drive a planar magnet to rotate such that a planar coil cuts through a magnetic field generated by the planar magnet so as to generate an induced electromotive force (EMF). Therefore, the present invention is novel, useful and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. An air-driven power generating device, comprising:
an air-driven portion;
a planar magnet, disposed on said air-driven portion and having a plurality of magnetic poles for generating an alternate magnetic field, said planar magnet being driven by said air-driven portion so as to change said alternate magnetic field;
a planar coil, disposed apart from said planar magnet for a distance, said planar coil having a plurality of induced regions so as to induce said alternate magnetic field to generate an induced electromotive force (EMF); and
a control circuit, electrically connected to said planar coil.

2. The air-driven power generating device as recited in claim 1, wherein said air-driven portion performs a rotating motion so as to drive said planar magnet to rotate.

3. The air-driven power generating device as recited in claim 1, wherein said air-driven portion is an air-driven rotating means.

4. The air-driven power generating device as recited in claim 1, wherein said air-driven portion communicates with a pipe with a high-pressure gas flow, thereby driving said air-driven portion to rotate.

5. The air-driven power generating device as recited in claim 1, wherein said plurality of magnetic poles correspond to said plurality of induced regions.

6. The air-driven power generating device as recited in claim 1, wherein said planar magnet is a multi-polar magnet.

7. The air-driven power generating device as recited in claim 1, wherein said control circuit provides rectification, electricity storage and power transmission.

8. The air-driven power generating device as recited in claim 1, wherein said planar coil comprises a plurality of patterned coils.

9. The air-driven power generating device as recited in claim 8, wherein said plurality of patterned coils are electrically connected in series.

10. The air-driven power generating device as recited in claim 8, wherein said plurality of patterned coils are electrically connected in parallel.
